(19) United States
(12) Patent Application Publication
(10) Pub. No.: US 2023/0141708 A1
(43) Pub. Date: May 11, 2023

(54) System And Method for Predicting End of Run for Equipment and Components of Such Equipment Based on Field Inspection and Operational Data

(71) Applicant: Suncor Energy Inc., Calgary (CA)

(72) Inventors: Russell Dean MACKIE, Calgary (CA); Adrian Sterling LOWELL, Calgary (CA); Erin Alana Suki KIYONAGA, Calgary (CA); Farshad TABASINEJAD, Calgary (CA); Waldo COETZEE, Calgary (CA)

(73) Assignee: Suncor Energy Inc., Calgary (CA)

(21) Appl. No.: 18/053,440

(22) Filed: Nov. 8, 2022

Related U.S. Application Data
(63) Continuation-in-part of application No. 17/938,519, filed on Oct. 6, 2022.

(30) Foreign Application Priority Data
Nov. 10, 2021 (CA) 3138441
Sep. 29, 2022 (CA) 3178935

(51) Int. Cl. G05B 19/4065

(52) U.S. Cl. CPC G05B 19/4065; G05B 2219/37245

(57) ABSTRACT

A system and computer-implemented method are provided for monitoring equipment. The method includes obtaining a trained model for an item, the item comprising equipment or a component of the equipment, the model having been trained using historical operational data of the type of equipment, and historical wear data acquired by inspecting the type of equipment and/or the type of component; using the trained model to generate an end-of-run prediction for the item using current or post service field inspection data for the item; analyzing the end-of-run prediction to determine a maintenance recommendation; and generating an output based on the prediction.

### CROSS-REFERENCE TO RELATED APPLICATIONS

This application is a continuation-in-part of U.S. patent application Ser. No. 17/938,519 filed on Oct. 6, 2022, which claims priority to Canadian Patent Application No. 3,138,441 filed on Nov. 10, 2021. This application also claims priority to Canadian Patent Application No. 3,178,935 filed on Sep. 29, 2022. The contents of these applications are incorporated herein by reference in their entirety.

### TECHNICAL FIELD

The following generally relates to predicting end of run for equipment and components of such equipment based on field inspection and operational data.

### BACKGROUND

Various industrial processes use equipment that is subject to wear and degradation during its operation. Such wear and degradation can occur to the equipment overall, such that the equipment, and its constituent components, wear out or experience an end-of-run; or can occur individually to certain components.

These individual components can experience different levels and/or rates of wear depending on their role and usage within the equipment's operation. Industrial equipment and, where applicable, individual components, are therefore often inspected for wear, damage, or failure, and are typically replaced based on a periodic schedule. When certain equipment includes multiple components that experience wear, if the operation of the equipment requires downtime to inspect and replace a component, multiple components may be replaced at the same scheduled time, whether or not they need to be replaced. Replacing equipment or components prior to wear out points can lead to wasteful use of resources, while running past these points can increase the risk of failure leading to unplanned outages and/or safety incidents.

### SUMMARY

The presently described system uses operational data for specific equipment, to build and train a model that can be used, along with ongoing operational data and inspection data acquired in the field, to generate end of run predictions for the equipment and/or components thereof.

In one aspect, there is provided a computer-implemented method for monitoring equipment, comprising: obtaining a trained model for an item, the item comprising equipment or a component of the equipment, the model having been trained using historical operational data of the type of equipment, and historical wear data acquired by inspecting the type of equipment and/or the type of component; using the trained model to generate an end-of-run prediction for the item using current or post service field inspection data for the item; analyzing the end-of-run prediction to determine a maintenance recommendation; and generating an output based on the prediction.

In another aspect, there are provided computer readable media for performing the method.

In another aspect, there is provided an equipment monitoring system, comprising: one or more processors; and memory, the memory storing computer executable instructions that, when executed by the one or more processors, cause the system to: obtain a trained model for an item, the item comprising equipment or a component of the equipment, the model having been trained using historical operational data of the type of equipment, and historical wear data acquired by inspecting the type of equipment and/or the type of component; use the trained model to generate an end-of-run prediction for the item using current or post service field inspection data for the item; analyze the end-of-run prediction to determine a maintenance recommendation; and generate an output based on the prediction.

In an implementation, the end-of-run prediction can further consider current operational data associated with the item.

In an implementation, the maintenance recommendation can include a replacement recommendation.

In an implementation, the maintenance recommendation can include a reuse or continued use recommendation.

In an implementation, the current field inspection data can be received from a mobile field application utilized at a site comprising the item. The current field inspection data can include at least one measurement indicative of wear of the item.

In an implementation, the current field inspection data and current operational data can be used to update the trained model.

In an implementation, the trained model can be one of a plurality of trained models, each trained model being associated with a different type of equipment or a different type of component.

In an implementation, the equipment can include a slurry pump. The item can include at least one component of the slurry pump. The at least one component can include a casing, a suction liner, an impeller, and/or a hub liner.

In an implementation, the operational data can include one or more physical properties of the equipment and/or a medium interacting with the equipment. The operational data can include cumulative hours, cumulative solids, a speed and/or a head the pump is creating, a percent Best Efficiency Point (BEP) flow, and/or any one or more of: i) a size distribution, ii) an amount of any solids that are being pumped, iii) a density of the slurry, and iv) where the pump operates.

In an implementation, the output based on the prediction can include a notification. A first notification can be provided to a first user device indicative of new data being provided from the site, and a second notification can be provided by the first user device to a second user device and is indicative of a recommendation based on the prediction. The second user device can be associated with a maintenance system or maintenance coordinator.

In an implementation, the output based on the prediction can include an alert. The alert can be indicative of a predicted end-of-run for the item being within a threshold amount of time for that type of item. The alert can be sent to a site supervisor, a maintenance system, or a maintenance coordinator. The alert can include a list of a plurality of items that are within the threshold.

In an implementation, the output based on the prediction can be provided at least in part by a mobile field application.

In an implementation, the output based on the prediction can be viewable in a user interface provided by a computing device. The computing device can be connected to an enterprise system. The user interface can provide wear data and operational data for a plurality of items. The user interface can provide an area view comprising data for a plurality of items. The user interface can provide a parts view comprising data for a plurality of components of the equipment.

Advantages of the system include the ability to accurately project into the future and predict and plan for end of run for components and/or equipment generally, as well as the ability to adapt and change predictions and maintenance planning based on ongoing operational data and field-inspected data.

### BRIEF DESCRIPTION OF THE DRAWINGS

Embodiments will now be described with reference to the appended drawings wherein:

FIG. 1 is a schematic diagram of an equipment monitoring and analysis system.

FIG. 2 illustrates an example of slurry pump comprising a number of components that experience wear during operation of the slurry pump.

FIG. 3 is an exploded view of a slurry pump illustrating components that can experience wear during operation of the slurry pump.

FIG. 4 is a schematic diagram of workflows among elements of the equipment monitoring and analysis system.

FIG. 5 is a schematic block diagram of an equipment management engine used in the system shown in FIGS. 1 and 4.

FIG. 6 is a graph illustrating a head ratio of a slurry pump over time.

FIG. 7a is a flow chart illustrating a process for training and utilizing a model for predicting end of run for equipment and/or components thereof.

FIG. 7b is a flow chart illustrating replacement/reuse recommendation generation.

FIG. 7c illustrates a new inspection data notification.

FIG. 7d illustrates a recommendation notification.

FIG. 7e is a flow chart illustrating alert generation.

FIG. 7f illustrates a summary list of components within an end-of-run threshold.

FIGS. 8, 9, 10, 11, 12, 13, 14 and 15 illustrate user interfaces for a mobile field app.

FIG. 16 is a user interface for a desktop tool, providing an area overview.

FIG. 17 is a user interface for the desktop tool, providing a component overview.

### DETAILED DESCRIPTION

A system is provided that uses operational data for specific equipment, to build and train a model that can be used, along with ongoing operational data and inspection data acquired in the field, to generate end of run predictions for the equipment and/or components thereof.

The system can be used with any equipment subject to wear during its operation, including equipment that is periodically inspected and includes parts or components that are replaced either when needed or according to a schedule. For example, end-of-run can be predicted, and this information utilized as described herein, for equipment such as slurry pumps, control valves, slurry spools, piping, and ore preparation equipment used in hydrocarbon recovery and processing operations. In the case of slurry pumps, for example, main components such as the casing, impeller, suction liner, and hub liner typically wear out at different rates. Conventionally, all of the components are replaced at once, or per predefined maintenance schedules (i.e., planned maintenance), even if some have not reached end-of-run. Since parts for this and other types of equipment can be significantly expensive, extending the service time of the components can result in significant economic advantages and reduce wasteful use of resources.

While described in the context of hydrocarbon recovery and processing-related operations, the system described herein can be adapted and configured to monitor and predict end-of-run for various other industrial equipment and/or components of such equipment, in industries such as manufacturing, utilities, etc.

As described in greater detail below, wear data can be fed into a process algorithm that trains a model to predict end-of-run for each component. Each component typically includes its own relevant parameters that indicate wear. For example, for slurry pumps, the thickness and inside diameter (ID) of the suction liner, the vane length and eye ID for the impeller, and the sidewall thickness of the casing, can indicate wear. This data can be obtained from inspections and entered via a mobile app in the field, which is used along with the trained model, to predict and adjust the end-of-run for the components. The model can also account for ongoing operational data for the particular component (or equipment more generally). This can include any suitable physical properties of the equipment and/or a medium interacting with the equipment. For example, in the case of slurry pumps, in addition to cumulative hours; cumulative solids (tonnage), the speed and the head the pump is creating, the percent Best Efficiency Point (BEP) flow (i.e., how far away from this is the pump operating), the size distribution and amount of the solids (if any) that are being pumped and the density of the slurry, and where the pump operates, among other things, can affect the end-of-run and can be incorporated in the trained model and used to predict or adjust a current prediction for end-of-run as these parameters change over time.

A user interface on the mobile app as well as a desktop tool or application can be used to display information such as the estimated end-of-run and how much of the run life of the component has been “used” up to the current date.

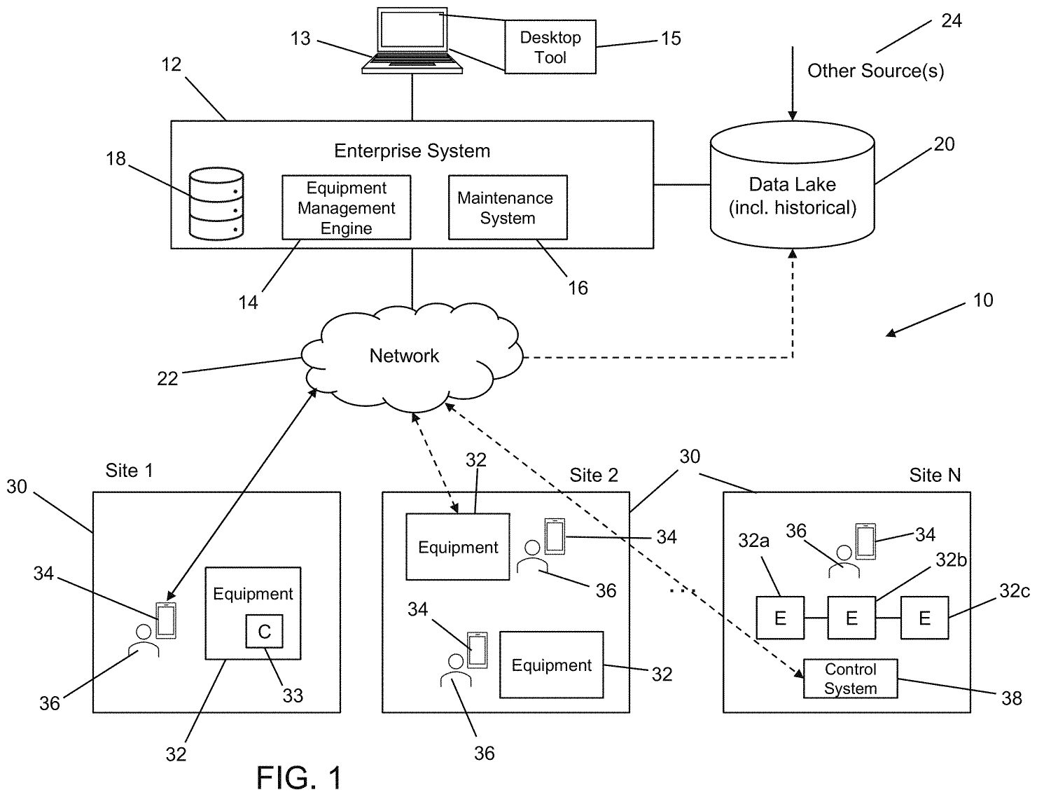

Referring now to the figures, FIG. 1 illustrates an equipment monitoring and analysis system 10 (hereinafter also referred to as the “system 10”). The system 10 includes an enterprise system 12 representing any computing platform and networked infrastructure used by an organization (e.g., via a computer 13 or computing station as shown) to monitor, communicate with and, optionally, automatically control equipment in one or more facilities. The enterprise system 12 includes at least one core database 18 that can be hosted on one or more servers within the enterprise system 12 which is configured to connect to one or more electronic networks 22, an equipment management engine 14, and a maintenance system 16 that can be used by maintenance personnel and/or administrators to schedule and deploy maintenance equipment, personnel, and any materials required to perform a maintenance operation associated with certain equipment, systems, plants, or facilities. For example, the maintenance system 16 can be instructed to replace or repair equipment 32 at various sites 30 within an operation or otherwise related to or associate with the enterprise system 12. The enterprise system 12 also includes or has access to a data lake 20, which can include a database or datastore for storing and consuming historical data, among other datasets such as ongoing operational data (that becomes historical data), enterprise data, device data, application data, etc.

The network 22 shown in FIG. 1 is an electronic network 22 such as a wired and/or a wireless communication system, for example, an existing enterprise communication infrastructure or purpose built network for the system 10. The electronic network 22 can include a communications network such as a telephone network, cellular, and/or data communication network to connect different types of communication devices. For example, the network 22 may include a private or public switched telephone network (PSTN), mobile network (e.g., code division multiple access (CDMA) network, global system for mobile communications (GSM) network, and/or any 3G, 4G, or 5G wireless carrier network, etc.), WiFi or other similar wireless network, and a private and/or public wide area network (e.g., the Internet).

The electronic network 22 in this example configuration provides connectivity with and/or into various sites, when to personnel or computing devices at such sites, or by being connected to instruments or computing devices within the sites 30. In this example, the network 22 provides connectivity into/with three exemplary sites 30, namely Site 1, Site 2 and Site N. While three sites 30 are shown in FIG. 1, it can be appreciated that any number of sites 30 can be within an organization or enterprise and be connected to the network 22 or otherwise be controlled by the organization associated with the enterprise system 12 (i.e., even if not connected to the network 22). The sites 30 are shown for illustrative purposes only to demonstrate potential connectivity of the system 10, and the system 10 can be configured to be connected to any one or more of these sites 30 in any configuration that suits a particular application. For example, the enterprise system 12 can be connected to multiple industrial processes at multiple sites within an organization.

To illustrate such configurations, Site 1 shown in FIG. 1 includes a piece of equipment 32 that includes at least one part 33 that may be repaired or, in the examples below, replaced. The part 33 is also capable of being examined or inspected by manual inspection, automatic (sensor-based) inspection, or both. In this example, an inspector 36 having a mobile device 34 such as a smartphone, tablet, or other computing device, can access the equipment 32 to inspect the equipment 32 and/or at least one component 33 such that manual inspection data can be entered into the system 10 via the mobile device 34, as discussed in greater detail below. While the example shown in FIG. 1 illustrates entry of inspection data via the mobile device 34 on-site, it can be appreciated that inspection data collected manually can also be entered into the system 10 via a desktop tool 15 within the enterprise system, within a computer 13 located within the enterprise system or on-site, or via any other suitable and available computing device that is connectable to the system 10. Furthermore, it can be appreciated that inspection data can also be loaded from files generated by certain measurements including laser scans. Inspection data can also be accessed with Application Programming Interfaces (APIs).

Site 2 in this example is shown to illustrate that a site 30 can include multiple pieces of equipment 32, each having parts 33 that experience wear and can be inspected to create manual inspection data. Site 2 in this example also includes multiple inspectors 36, each having a personal mobile device 34 to permit inspection data to be entered.

Site N in this example is shown to illustrate that various pieces of equipment 32a, 32b, 32c can be interconnected in a sub-system such as a train of devices that are tasked with performing a particular operation in unison or otherwise collectively. An inspector 36 can also access and inspect such equipment (E) 32a, 32b, 32c and enter inspection data via a mobile device 34. The equipment 32a, 32b, 32c can also include components 33 that experience wear and can be inspected. Site N also illustrates a control system 38, which can be used to control one or more aspects of an industrial process such as one utilizing equipment 32a, 32b, 32c. The control system 38 can be integrated into the system 10, e.g., if any control operations can be affected by determinations, instructions, reports or other data generated by the system 10, e.g., by the equipment management engine 14, maintenance system 16, or both. For example, an industrial process can include a single or multiple digital control systems (DCSs) 38 to operate that process. Such control systems 38 can be integrated with operational inputs or control parameters of the equipment 32a, 32b, 32c. The control systems 38 can also be configured to be integrated with measurement instruments or sensors to gather data to be added to the data lake 20. The control system 38 shown in FIG. 1 can be used, for example, to automatically shut down equipment 32 (e.g., when a wear condition is detected), or to provide a local alarm or alert to on-site personnel. The control system 38 can also represent, or be otherwise provided by the maintenance system 16 directly to control operations on-site and/or with the equipment 32 or components 33 directly and thus the control system 38 shown in FIG. 1 can be symbolic of any control imparted by the system 10, on-site. As shown in FIG. 1, the data lake 20 can be populated using both data gathered at each site as well as from other sources 24, such as data historians, third party sources of ambient conditions (e.g., ambient temperature), meta data (e.g., mapping of tags to model variables), economic data (e.g., maintenance costs) etc. As shown using a dashed line, the data lake 20 can optionally be accessible via the network 22 directly or may require access via the enterprise system 12.

The computer 13 coupled to the enterprise system 12 as shown in FIG. 1 represents any device utilized by personnel such as reliability, performance or other engineers and operators, as well as maintenance personnel (who may also have access via the maintenance system 16). The computer 13 can be used to access the desktop tool 15 provided by the enterprise system 12 to leverage and consume data generated by the equipment management engine 14 as described further below.

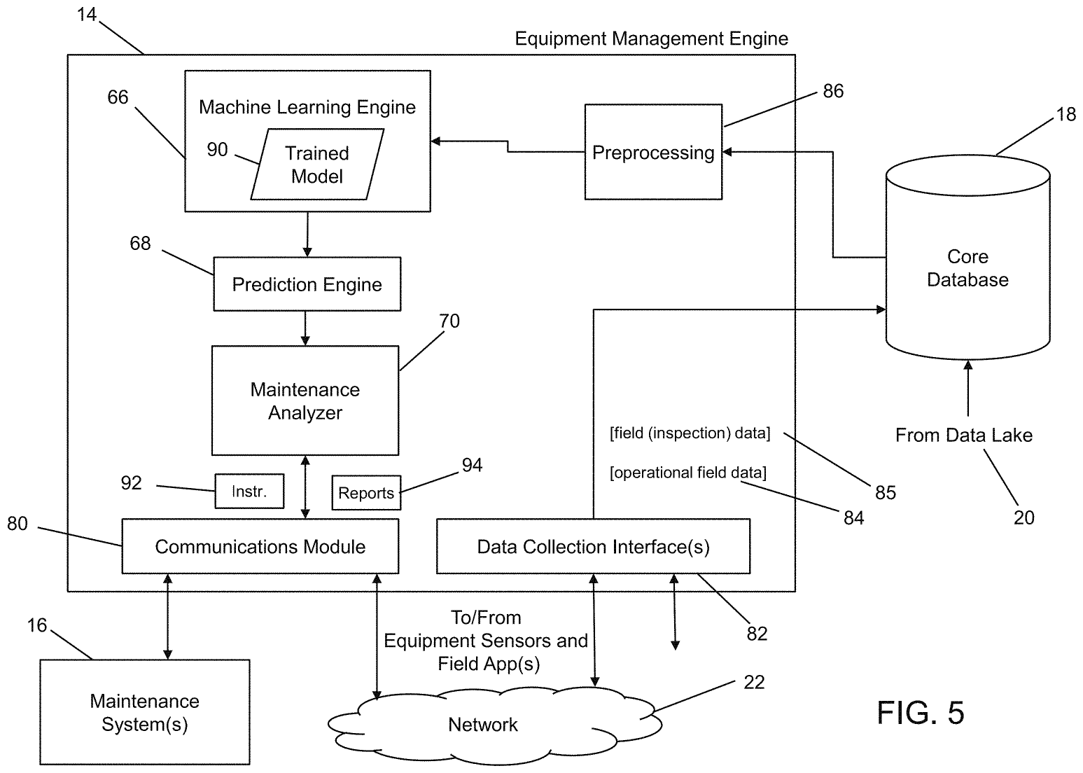

Some equipment 32 used in heavy industrial applications such as hydrocarbon extraction, processing and refinement can be subjected to the handling of abrasive fluids such as slurries. Examples of such equipment 32 can include slurry pumps, piping liners and other pipeline components; and pressure vessels/tanks, valves and pumps, to name a few. The slurries handled by the aforementioned equipment 32 can be extremely abrasive, which leads to the erosion of the internal components of the equipment. Equipment 32 such as slurry pumps are often proactively replaced or serviced during routine downtime rather than waiting for the pumps to fail. That is, it is found that to avoid the disruption of a leakage, internal components of the equipment are often serviced or prematurely replaced, which can lead to additional cost as note above. The system 10 can be used to model operational data, including historical data over multiple runs using such equipment 32, to train a model 90 (see FIG. 5) that predicts end-of-run. Manually acquired inspection data, entered via the mobile devices 34 used by inspectors 36, can be used with the trained model 90 to predict an end-of-run and adapt to changing conditions and inform maintenance scheduling and part replacement scheduling.

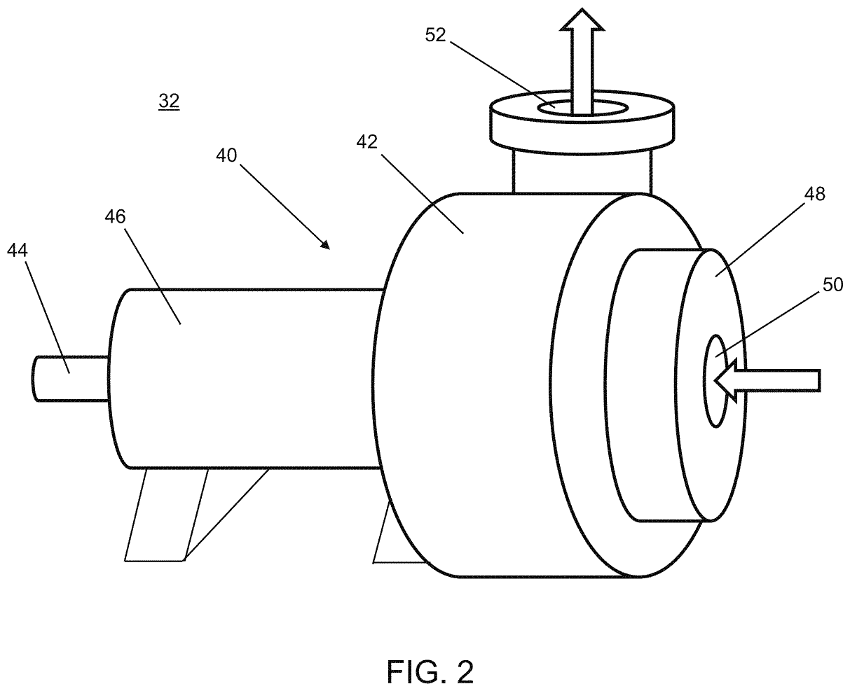

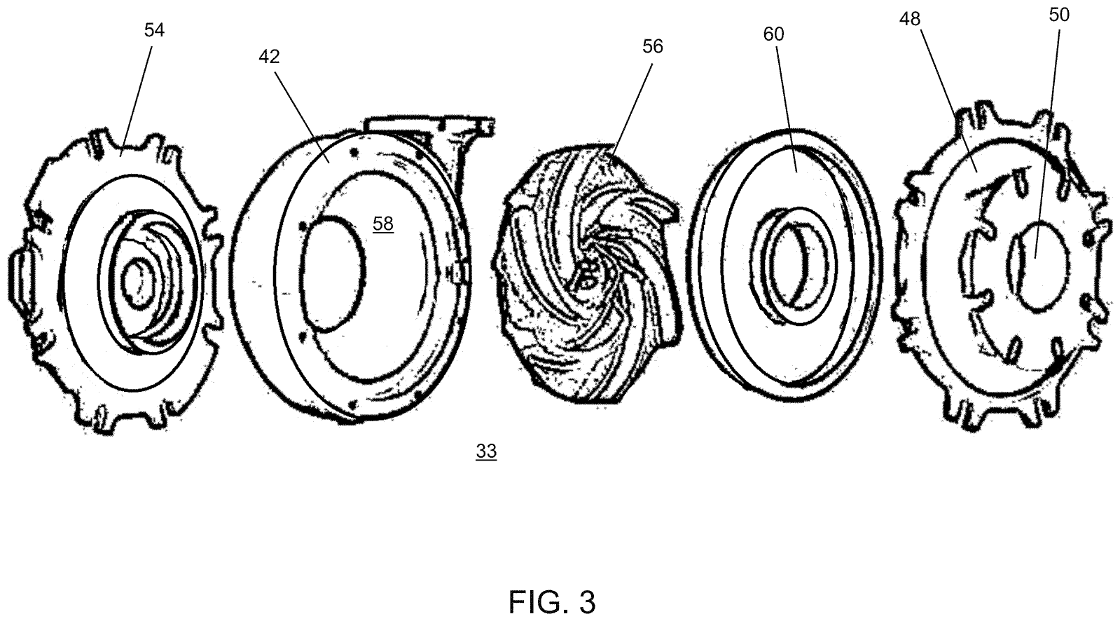

FIG. 2 illustrates a slurry pump 40, which represents one of various types of equipment 32 that can be monitored by the system 10. The slurry pump 40 includes a pump casing 42 that contains certain internal components (see FIG. 3). The pump 40 is driven by a drive shaft 44 that is powered by a motor 46, e.g., an electric drive motor. The motor 46 is mounted to the pump casing 42 and is itself can be mounted to other apparatus such as a frame (not shown) or surface such as a floor. The pump casing 42 has a suction cover 48 that includes or otherwise defines a pump or suction inlet 50. The pump casing 42 also includes a pump or discharge outlet 52.

Referring also to FIG. 3, the pump casing 42 is attached to the motor 46 via a stuffing box cover 54. The casing 42 contains an impeller 56 that rotates within a chamber 58 defined by the casing 42. The casing 42 also contains a suction cover liner or “suction liner” 60. The suction liner 60 is thus also an internal component of the pump 40. The suction liner 60, rather than hold pressure, serves as a “front-line” degradation component. The suction liner 60 is typically made of a degradation-resistant material such as chrome white iron, rubber, polyurethane or hardened tungsten steel. The suction liner 60 is meant to be the first component to fail in the pump 40 and when it begins to degrade (e.g., erode, corrode, wear, thin or be otherwise damaged), and indicate impending failure, permits leakage through weep holes (not shown) in the suction cover 48. The suction liner 60 is therefore typically changed periodically as a preventative measure, e.g., during a preventative maintenance operation. The components shown in FIG. 3 therefore represent examples of parts 33 of equipment 32 (i.e., slurry pump 40 in this example) that can be monitored by the system 10.

While certain examples provided herein refer to degradation monitoring of slurry pumps, it can be appreciated that the principles discussed herein can be adapted and applied to other types of equipment 32 having at least one internal component 33.

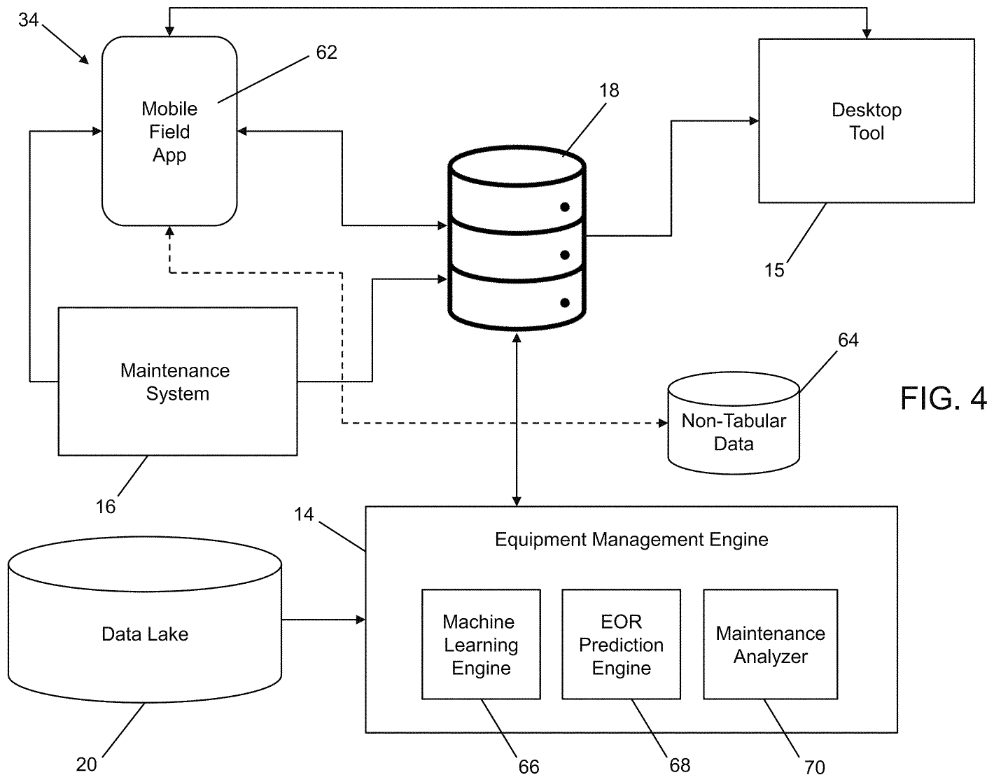

FIG. 4 illustrates an example of a workflow that can be implemented using the system 10. A mobile field app 62 is provided that can be loaded on, and used by, the mobile device 34 of an inspector 36 to enter manually acquired inspection data in the field, e.g., by visually inspecting and/or measurement components 33 of the equipment 32 at a site 30. The data (e.g., measurements, inspection dates, replacement dates, etc.) entered via the mobile field app 62 is sent to the core database 18. The core database 18 can also communicate with the mobile field app 62 to provide current data for the particular equipment 32 or part 33 of interest, such as the cumulative hours, tonnage, tag data, etc. The mobile field app 62 can also communicate with a non-tabular data storage 64 to upload photos of equipment and/or the inspection process. The storage 64 is provided in this example implementation to separately store photos to facilitate photo sharing amongst personnel.

The maintenance system 16 can be coupled to the core database 18 to provide details of work orders, planned maintenance dates, replacement schedules, etc., which can then be used to populate information in the mobile field app 62 as well as the desktop tool 15. The maintenance system 16 can also be coupled to the mobile field app 62 directly to enable an inspector 36 in the field to provide recommendations for prolonging a part replacement according to the inspection data.

The desktop tool 15 is coupled to the core database 18 to obtain data for visualization and monitoring by personnel not necessarily in the field. Such data can include time remaining, cumulative hours/tonnage, detailed model outputs, graphical data, etc. The desktop tool 15 therefore can provide additional processing and visualization power to an analyst or operator when compared to the mobile field app 62, used for visualization and inspection data entry.

FIG. 4 also illustrates the equipment management engine 14, which can be implemented using a machine learning platform such as the cloud-based Azure® platform. The engine 14 can receive tag data, flow, speed and other operational data from the data lake 20, and can provide model results and tag data to the core database 18. The engine 14 can also receive model configurations, user inputs, and maintenance data via its connection to the core database 18.

As shown in FIG. 4, the equipment management engine 14 provides a platform, system, or device that can be configured to provide or otherwise incorporate or utilize a machine learning engine 66, an end-of-run (EOR) prediction engine 68, and a maintenance analyzer 70, details of which are described below.

Referring now to FIG. 5, an example of a configuration for the equipment management engine 14 is shown. The equipment management engine 14 includes a communications module 80 configured to communicate via a direct connection or by way of an indirect connection via the network 22, with the maintenance system 16. The communications module 80 can also be used by the equipment management engine 14 to communicate with entities, systems and devices external to the enterprise system 12 as illustrated in FIG. 1. The equipment management engine 14 also includes one or more field data collection interfaces 82 to enable the equipment management engine 14 to communicate via the network 22 with equipment 32, parts 33, and mobile field apps 62, as well as devices, systems, sensors, and other entities to obtain data from a site 30, equipment 32, part 33, control system 38 or other sources or locations within the wider system 10. As shown in FIG. 5, this can include data connections with the network 22 as well as other interfaces to enable direct entry of data and/or communications, e.g., via computers 13 within the enterprise system 12. The field data collection interface(s) 82 are also configured to populate the core database 18 with data to be used in determining end of run predictions and maintenance scheduling as herein described. The core database 18 can also be updated with data that resides in the data lake 20. In this example, the field data collection interface(s) 82 can collect, receive or otherwise obtain operational field data 84 (e.g., sensor data, instrument data, manual inputs from a plant, apparatus or process, etc.), as well as field (inspection) data 85 entered via the mobile field app(s) 62. With respect to operational field data 84, it should be noted that there are sensor technology improvements such as mounted Ultrasonic Testing (UT) probes that allow for continuous (or high frequency) wear monitoring (e.g. casing and suction liners) that can serve to substantially increase the training data set. Another example is an ability to measure the impeller nose gap with UT from the suction liner (which may only be possible during certain operating ranges). Furthermore, it can be appreciated that the field (inspection) data 85 can also be obtained from post service inspections whereby measurements are made on components already taken out of service thereby avoiding downtime to conduct inspections. Field (inspection) data 85 may also refer to files (e.g., electronic outputs from laser scans) or vendor measurement databases. Furthermore, both field (inspection data) 85 and operational field data 84, may include weight measurements taken as needed or fed from sensors (e.g. load cells). In other words, various data indicative of wear can be used, in addition to directly measuring the component 33 or equipment 32.

It can be appreciated that the equipment management engine 14 can be implemented using a client device (e.g., computing device 13 shown in FIG. 1) which includes one or more processors other data storage devices storing device data and application data (not shown), the processor(s) being configured to execute instructions that utilize the modules and components shown in FIG. 5, including the communications module 80 and field data collection interface(s) 82 by implementing communication protocols utilized by the particular configuration and/or application. That is, while not delineated in FIG. 5, the equipment management engine 14 includes at least one memory or memory device that can include a tangible and non-transitory computer-readable medium having stored therein computer programs, sets of instructions, code, or data to be executed by a processor. It can be appreciated that any of the modules and applications shown in FIG. 5 may also be hosted externally and be available to the equipment management engine 14, e.g., via the communications module 80 or field data collection interface(s) 82. The device data, can include, without limitation, an IP address or a MAC address that uniquely identifies client device 13 within the system 10. The application data, can include, without limitation, login credentials, user preferences, cryptographic data (e.g., cryptographic keys), etc.

Other modules not shown in FIG. 5 that can also be utilized by the equipment management engine 14 and/or client device 13 configured to implement same include, without limitation, a display module for rendering GUIs and other visual outputs on a display device such as a display screen, and an input module for processing user or other inputs received at the client device 13, e.g., via a touchscreen, input button, transceiver, microphone, keyboard, etc.; standard or customized applications or “apps”, and a web browser application for accessing Internet-based content, e.g., via a mobile or traditional website.

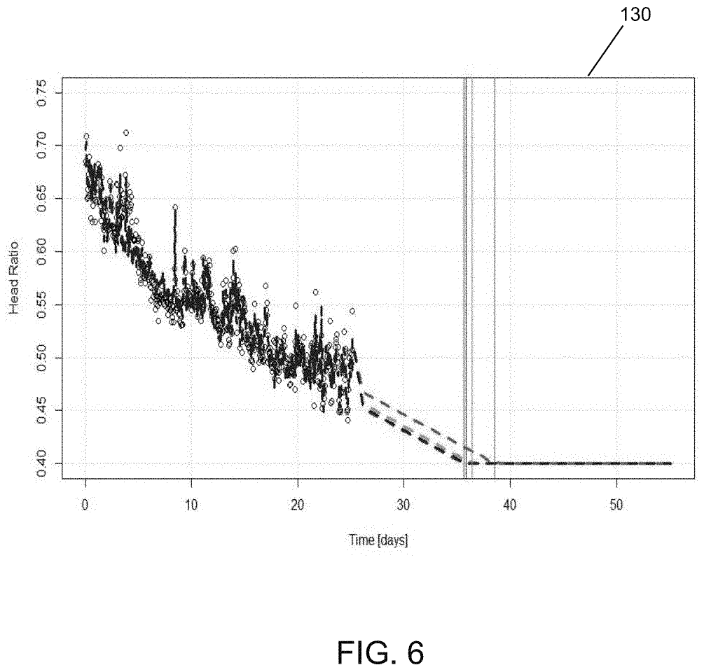

To utilize data available in the core database 18 and to perform statistical modelling, the equipment management engine 14 can include various modules as shown in FIG. 5 that are arranged and configured to process and analyze data according to both engineering (i.e., first) principles and using advanced data-driven analytics using machine learning and/or other advanced automation algorithms. In this example, the equipment management 14 includes a preprocessing module 86 to prepare, transform, and clean the historical data obtained from the data lake 20 and manual inspection data 85 as well as other operational field data 84 that populate the core database 18. The preprocessing module 86 can be used to not only clean and normalize data, but also perform computations, such as to convert raw data into key performance indicators (KPIs) or other useful outputs that can be used by the machine learning engine 66 in building, training and refining the model 90 as well as using same. An example of operational data 84 that can be processed in the preprocessing stage 86 is shown in FIG. 6, which is a graph 130 that illustrates head ratio data for a slurry pump 40 over time and illustrates a prediction or extrapolation that can be determined by the engine 14. The prediction is made for different operational scenarios e.g., larger and smaller median particle size. It can be appreciated that the example shown in FIG. 6 is purely illustrative of one of many operational parameters and/or physical properties of the equipment 32 being monitored that can be considered by the machine learning engine 66 in building and refining the trained model 90 for the corresponding equipment 32. The machine learning engine 66 uses the preprocessing stage 86 outputs to generate one or more trained models 90 that can be used to perform a prediction using a prediction engine 68 to generate a prediction that can be used by a maintenance analyzer 70 (also referred to as the “analyzer 70” for brevity). The analyzer 70 can use a prediction generated by the prediction engine 68 to, for example, recommend an alternative replacement schedule for a part 33 according to a predicted end of run for that part 33 determined, in part, from the field data 85 entered during an inspection. The analyzer 70 can also use a prediction generated by the prediction engine 68 to determine an optimized maintenance or replacement schedule for a train or interconnected set of equipment 32a, 32b, 32c (e.g., as shown at Site N in FIG. 1).

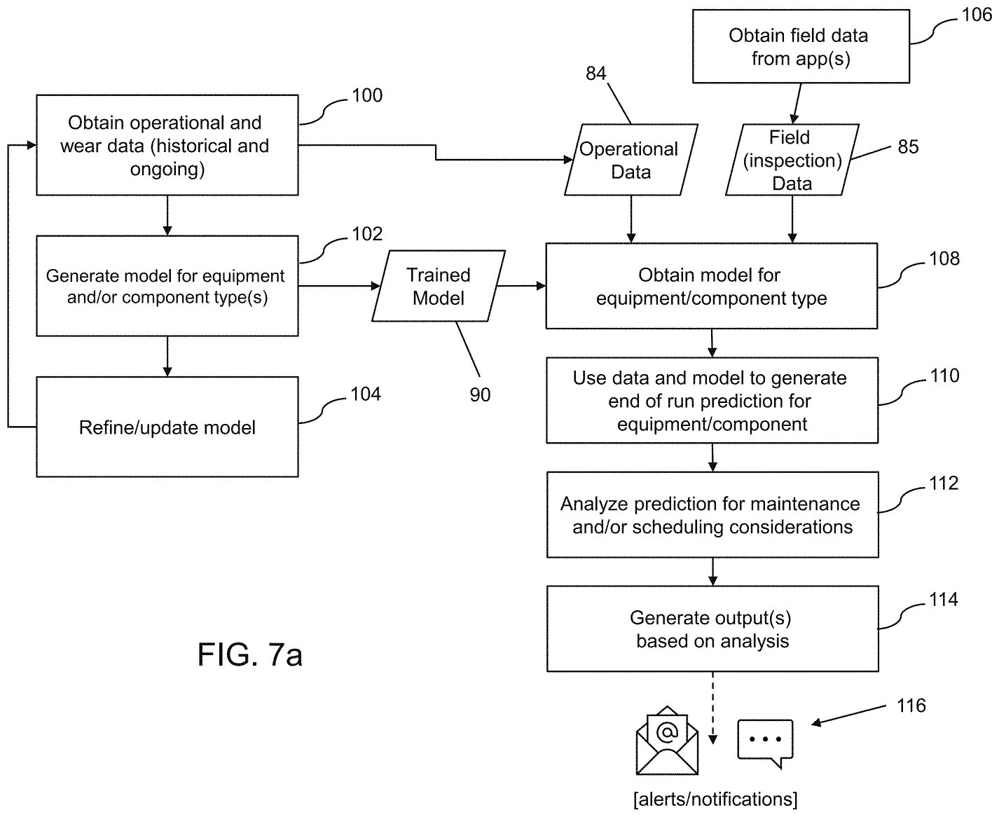

The analyzer 70 can generate instructions 92 or reports 94 that can be communicated to a site 30 via the network 22 or can be provided to the maintenance system 16. As shown in FIGS. 7a through 7f, and described more fully below, the analyzer 70 can also be involved in generating alerts and notifications that are selectively sent to key personnel associated with the system 10. It can be appreciated that the maintenance system 16 can also be further integrated with the equipment management engine 14, e.g., to include the analyzer 70 or the entirety of the equipment management engine 14 in other configurations. The instructions 92 can include commands for control systems 38 to implement automated changes or can include instructional information for an operator for manual operational changes or to automatically shut down an apparatus.

As illustrated in FIG. 5, the machine learning engine 66 can be used to not only generate the trained model 90 based on historical data and currently obtained data, but also to feed current data (including field data 85) to the prediction engine 68 to generate a current prediction for the analyzer 70. The historical data that is used to train the model 90 can be updated with the most recent data every time that the model 90 runs. That is, the model 90 can be configured to always use an up to date training dataset. It can be appreciated that the model 90 being trained is typically a wear rate. Field inspection data 85 can be used to quantify responses (wear) while the cumulative solids and/or time online could be a more significant variable. At the minimum, with two field measurements and timestamps, wear over time can be calculated based purely on field inspection data. As noted elsewhere, wear is also dependent on other factors. These other factors are typically ascertained from operational field data 84. In a simple example, the model 90 can then be trained with field measurements (85, responses), time online (85, 84, variable), particle size (84, variable), pump speed (84, variable) etc. This example would be a multivariate model 90 using both field inspection data 85 and operational data 84 from sensors and or laboratory analyses.

In the configuration shown in FIG. 5, the preprocessing module 86 can be configured to compute wear variables as an indicator of the predicted end-of-run for a slurry pump 40 as one example of equipment 32 that can be monitored. In such an example, the wear variables can be used along with operational values such as cumulative hours; cumulative tonnage, the speed/head the pump is creating, the percent Best Efficiency Point (BEP) flow (i.e., how far away from this is the pump operating), the size and amount of the solids (if any) that are being pumped and the density of the slurry, and where the pump operates, among other things, to predict the end-of-run for a part 33, based on current conditions. It can be appreciated that by using the engine 14, an operator or engineer can, for example, determine whether an end of run for a component 33 or equipment 32 can be extended. For example, site engineers can see how much they can stretch out a run on a component 33 to avoid unnecessarily replacing the component 33 too early.

It can also be appreciated that outcomes from the prediction engine 68, can be used as inputs to the process simulation(s) 88, thereby enabling simulations based on predicted wear behavior. The outcome from these simulations can be issued as report(s) 94, or/and as additional inputs to the maintenance analyzer 70. Information exchanged between these steps could be automated or entered by users.

FIG. 7a is a flow chart illustrating a process for training and utilizing a model 90 for predicting end of run for equipment 32 and/or components 33 thereof. At block 100, the machine learning engine 66 obtains operational and wear data related to a component 33 or equipment 32 for which the model 90 is being trained. Initially, historical data is used to train an initial model 90, e.g., by capturing multiple runs for various equipment over time, to develop model parameters that can be used to infer and predict based on ongoing data, including measurements obtained from the field app 62. At block 102, the machine learning engine 66 generates a model 90 for that equipment type and/or component type.

On an ongoing basis, the machine learning engine 66 can refine and update the trained model 90 as new data is acquired, e.g., by iterating through operations 100 and 102. At block 106, field data 85 is acquired via the field app 62. Operational data 84 is also provided via sensors or other inputs available to the system 10.

At block 108 the prediction engine 68 obtains the trained model 90 for the equipment 32 or component 33 that relates to the operational data 84 and the field data 85 and uses that data 84, 85 and the trained model 90 at block 110 to generate an end-of-run prediction for the particular piece of equipment 32 and/or a component 33 thereof.

This end-of-run prediction can be a new prediction or a refinement or verification of an existing end-of-run value and can propagate through the system such that, for example, the analyzer 70 can analyze the prediction for maintenance and/or scheduling considerations at block 112. The system 10 can then generate one or more outputs at block 114, which can include inputs sent to the maintenance system 16, control instructions, or alerts/notifications at block 116. The alerts/notifications at block 116 can include emails or other electronic messages, chat messages, project management updates, etc. FIG. 7b illustrates a notification and recommendation message flow at block 116, in this example, denoted by 116a. At block 200, the system 10 obtains field data from the mobile field app 62. This may be performed by an on-site inspector 36 such as a millwright or other personnel. At block 202, the site lead is notified that such field data has been collected by the on-site personnel. At block 204, the site lead is then responsible for using that data to make a recommendation for replacing or reusing the component that has been measured. This can be done using the mobile field app 62 as illustrated further below. The system 10 then sends the replacement/reuse recommendations to a maintenance coordinator, e.g., by sending a notification to the maintenance system 16. The maintenance coordinator, who in this example is ultimately responsible for making the decision, can agree with or ignore the recommendations by taking into account various other factors. However, the replacement/reuse recommendations provide additional insights from others within the system 10 to enable the maintenance coordinator to make more informed decisions.

FIG. 7c illustrates a message or notification 210 that can be provided to the site lead to notify them of when the new inspection data has been entered via the mobile field app 62 and is available for review. The notification can be provided as a push notification, text message, email, etc. A link 212 to the inspection app 62 and inspection data can be provided to provide ease of navigation to the data for the site lead. FIG. 7d illustrates a summary 214 of the inspection that can be viewed by the site lead on the mobile field app 62 or desktop tool 15. In this example, the summary 214 includes a photo link 216 to allow the site lead to drill down into the inspection by obtaining photos taken during the inspection.

FIG. 7e illustrates an alert message flow as part of 116 in FIG. 7a, denote 116b in FIG. 7e. At block 300 the system 10 obtains outputs from an analysis of inspection data, operational data, or both. In this example, at block 302, the system 10 determines if the predicted end-of-run is within a threshold number of hours for a given part. This is to proactively detect components 33 that are worn within a particular tolerance or setpoint identified by the threshold and to then generate an email (or other message) at block 304 that is sent to the site 30 with a list of parts with low life remaining at the agreed upon interval. In this way, an intervention such as a part replacement or secondary inspection can be made. Such a list is shown by way of example in FIG. 7f.

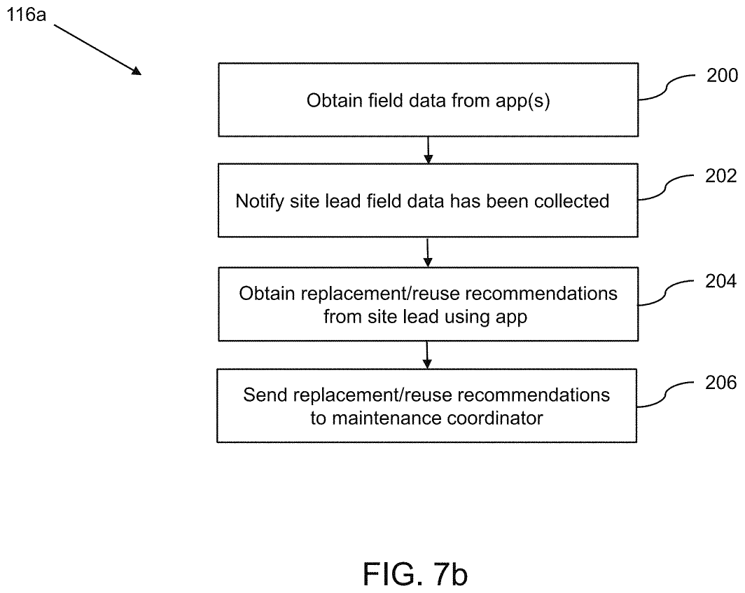

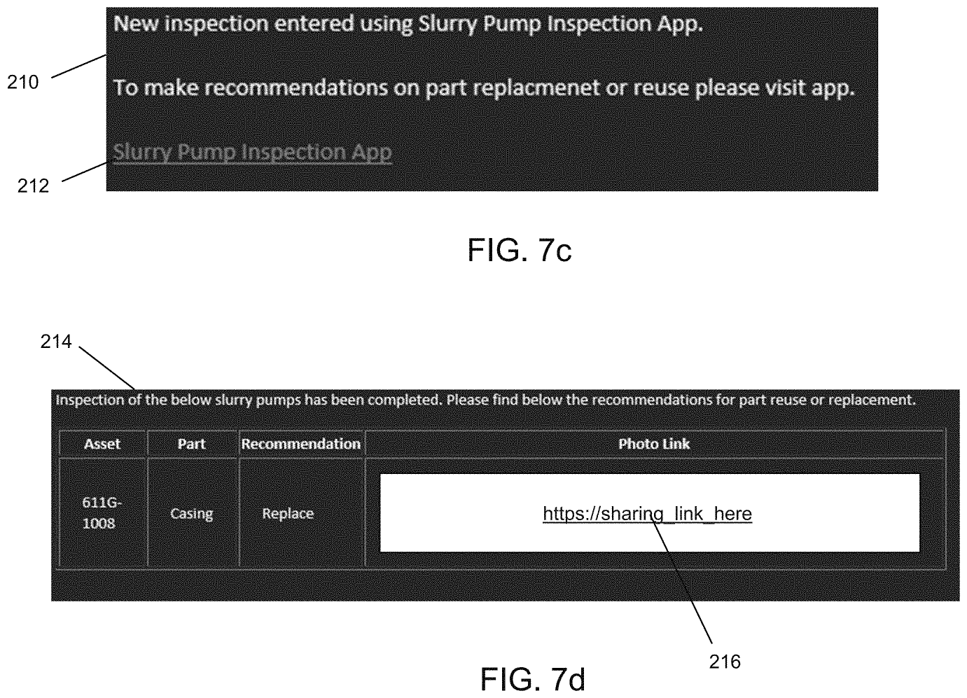

FIGS. 8 through 15 illustrate example user interfaces provided by the mobile field app 62 to enable inspectors 36 and other personnel to enter and view field data with respect to equipment 32 and components 33 at various sites 30 within an organization. Referring first to FIG. 8, a selection page is shown which enables the user to select a site 30, e.g., via a drop-down menu 150 as shown. Once a site 30 is selected, the user can select an Inspection and Current Status option 152 or a Recommend Replacements option 154. The Current Status option 152 enables the user to view existing, or add a new, inspection or to obtain status information. By selecting option 152, the view shown in FIG. 9 can be displayed. This view enables the user to select an area of the site 30 using drop-down menu 156, to select a train (of equipment 30) using drop-down menu 158, and to select an asset using drop-down menu 160. A current status option 162 can be selected to view status details for that asset. Previous inspections can be viewed by selecting a previous inspections option 164, and a new inspection can be entered by selecting a new inspection option 166.

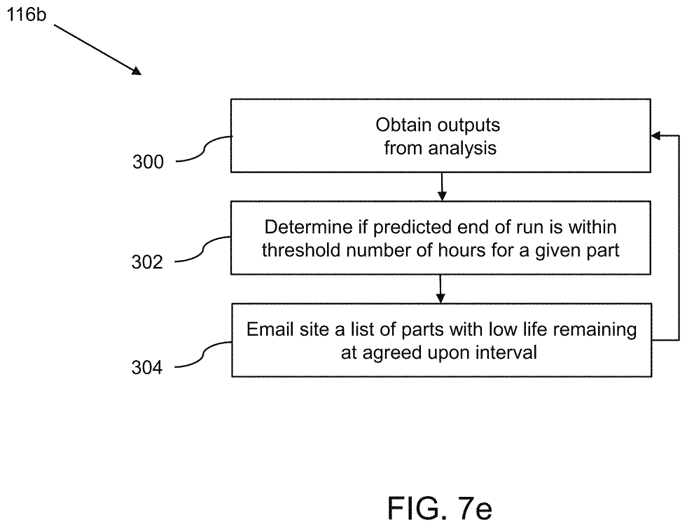

FIG. 10 illustrates an inspection page that can be displayed by selecting the new inspection option 164 in FIG. 9. In this screen, a Suction Liner tab 170 is selected, which represents a component 33 of a slurry pump 40 in this example. If the inspector 34 is entering inspection data for this suction liner, a number of fields and selections 172 can be made. This includes an inspection date, contextual options (break in work, replaced, adjusted, etc.), and measurement entry boxes (e.g., for thickness and Eye ID measurements in this example). A finish and review option 174 can be selected to enter the data.

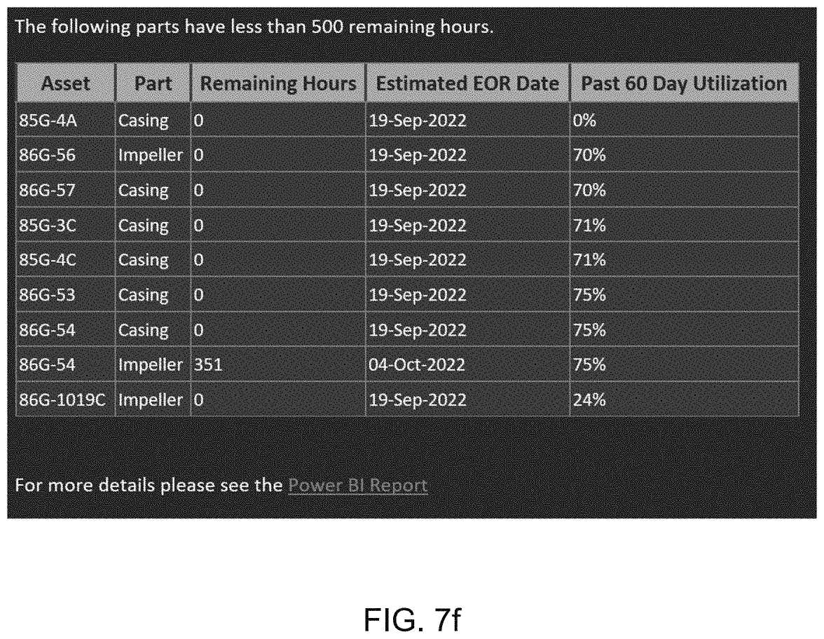

FIG. 11 illustrates a current status screen, which can be opened by selecting the option 162 shown in FIG. 9. Here, predictive analytics model deviation values can be colour-coded to indicate operational health. This screen can be used in the field to allow an inspector 36 (or other personnel) to quickly and conveniently get a snapshot of the current health of that component 33 or equipment 32. In FIG. 11, the overall equipment health tab is shown and similar data can be shown for each component 33 via selection of additional tabs. The current status information 180 includes pump status, an indication of the part with the shortest end-of-run (e.g., impeller in this snapshot), shortest remaining hours, and earliest projected end-of-run date. A current head ratio graph can also be shown, among other data not shown in FIG. 11 for ease of illustration.

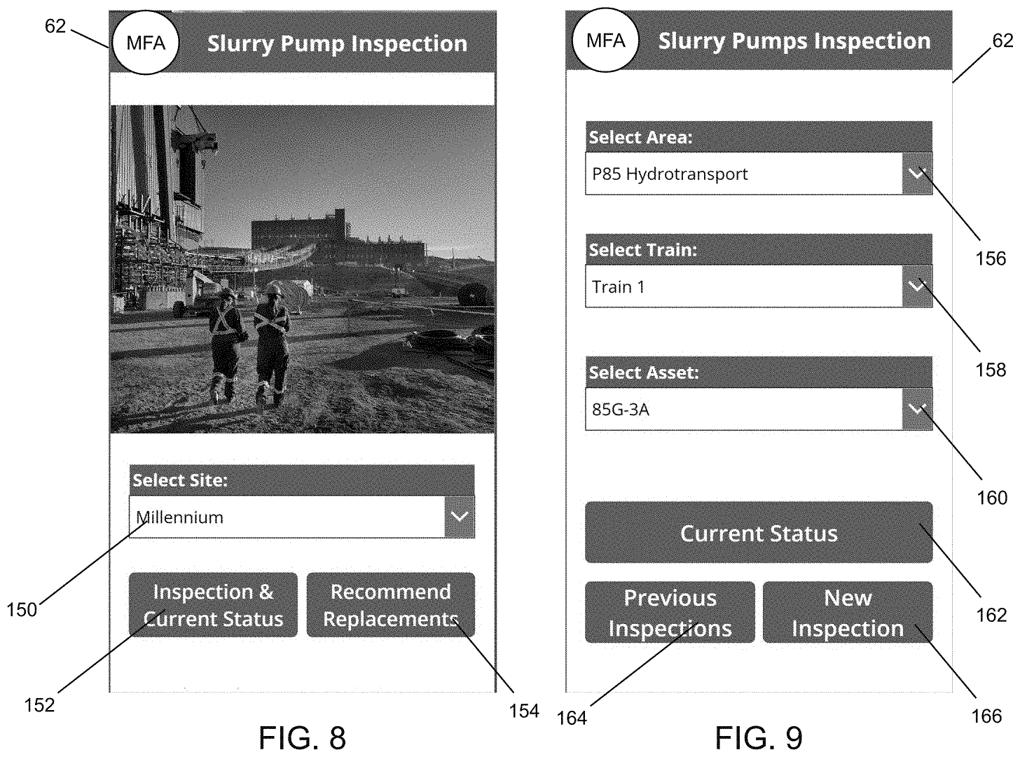

FIG. 12 illustrates a current status tab 190 for a casing component 33. These tabs can be used to drill down into individual components 33 and determine component details 192, such as current cumulative hours, the predicted end-of-run at that time, critical location and inspection history/replacement details, as well as options to view measurement data (graphs) for certain characteristics such as the belly thickness of the casing in this example. It can be seen that a current predicted thickness is shown as well as a worn value that provides a glimpse of how much wear life is left for this component 33.

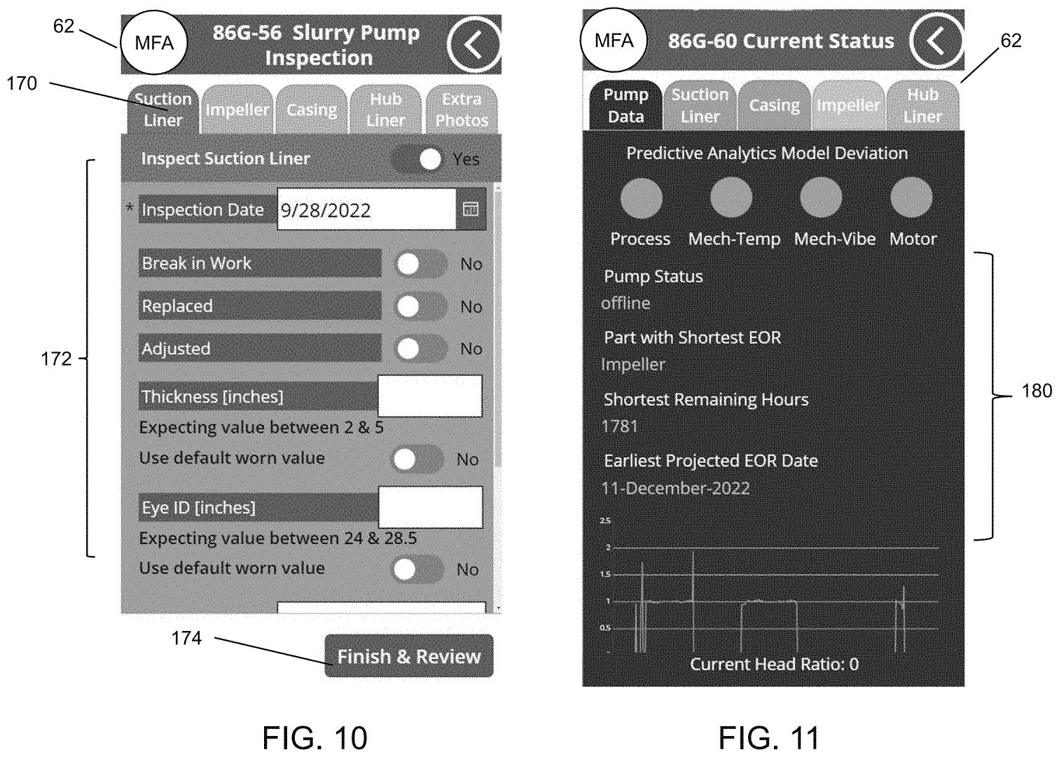

FIG. 13 illustrates a previous inspection screen that can be loaded by selecting the previous inspections option 164 in FIG. 9. Here, details of a past inspection can be shown, including the date, measured value(s), contextual details, comments, and photos. It can be appreciated that the screen shown in FIG. 13 can also represent a current inspection in progress. The new photo button 194 is provided to enable additional photos to be added in such a case.

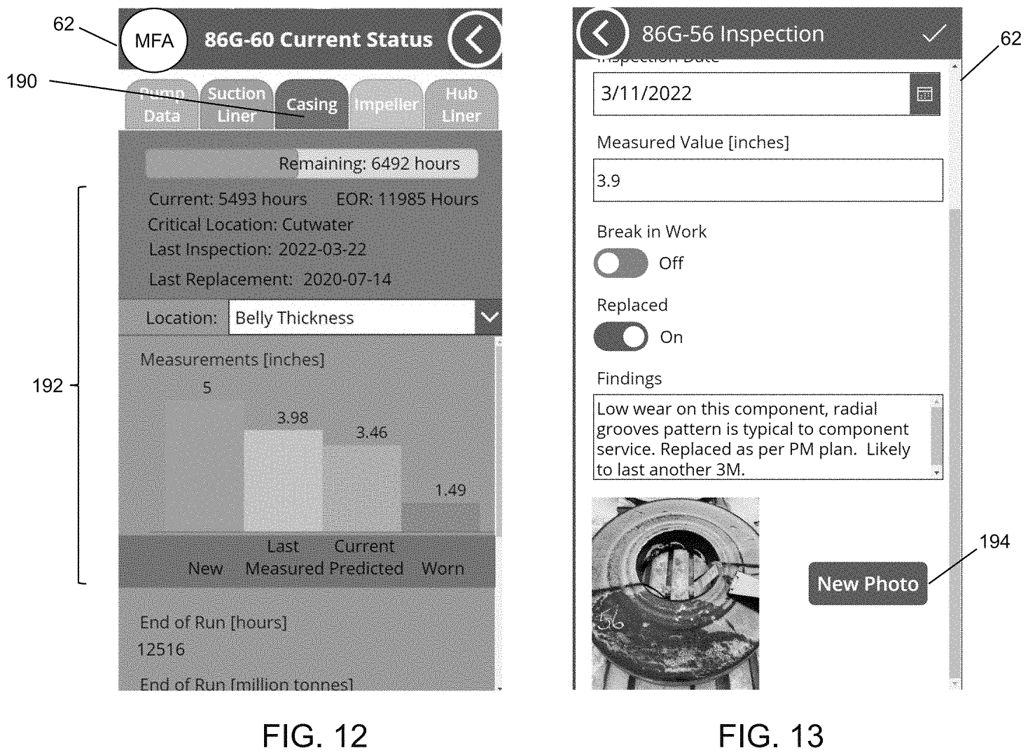

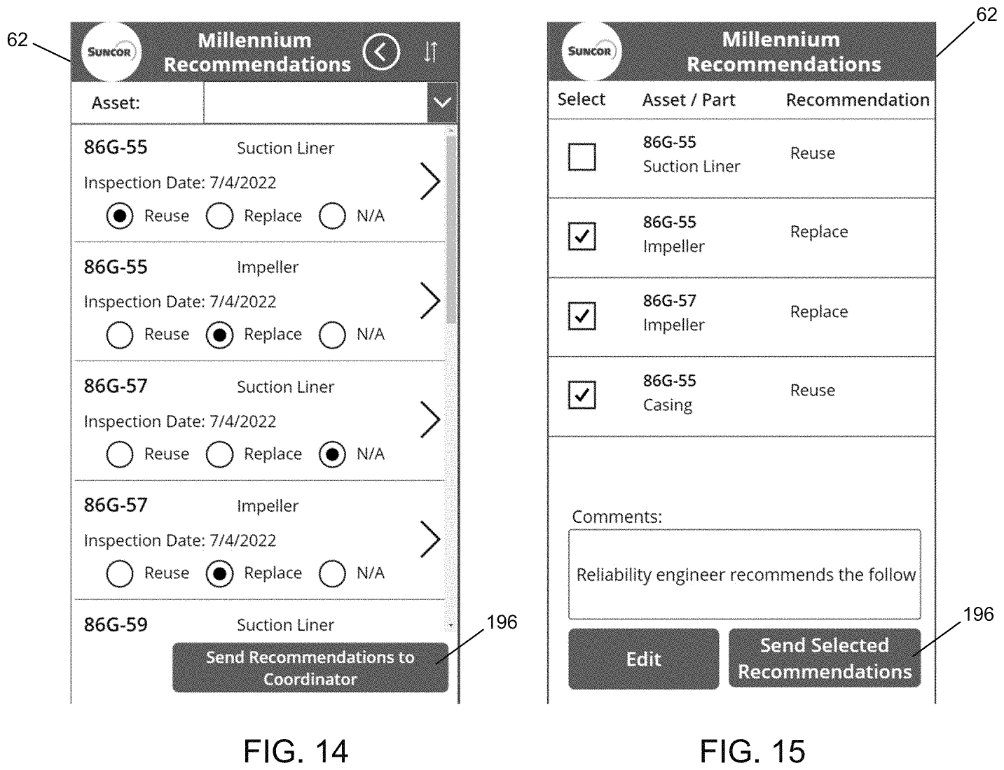

Referring again to FIG. 8, a recommend replacements option 154 can be selected to allow an inspector 36 or other personnel to make recommendations, which can be particularly convenient for field workers that have access to the mobile field app 62. A recommendation screen is shown in FIGS. 14 and 15, which allows a user to scroll through assets (e.g., equipment 32 and/or components 33) at a site 30 and select recommendations such as “reuse” or “replace” or “not applicable” and send recommendations to a coordinator by selecting option 196. FIG. 15 illustrates an equipment screen that allows the user to drill down into the components 33 of a piece of equipment 32 to select or de-select the recommendations for specific components 33. Comments can be added and editing features can also be provided.

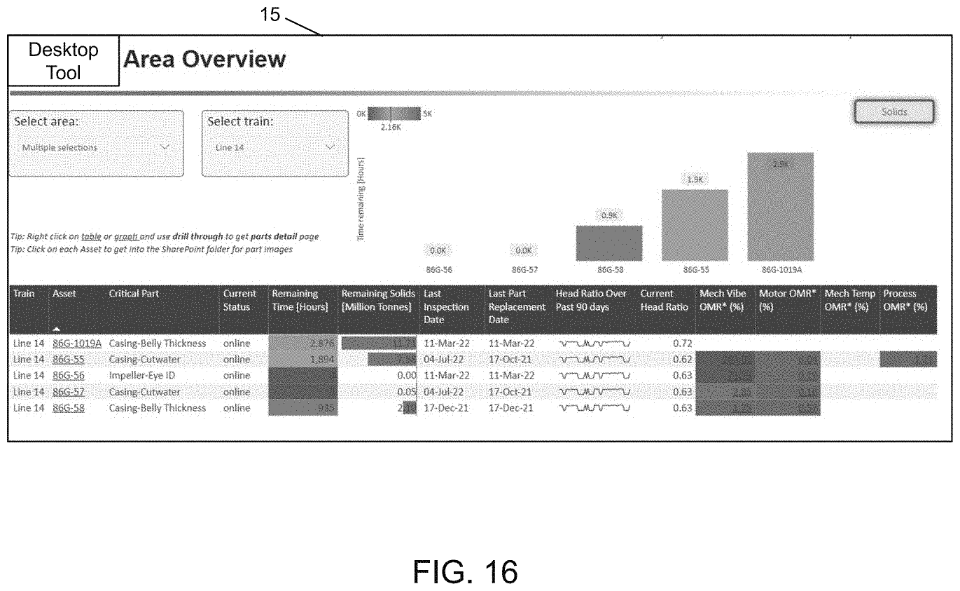

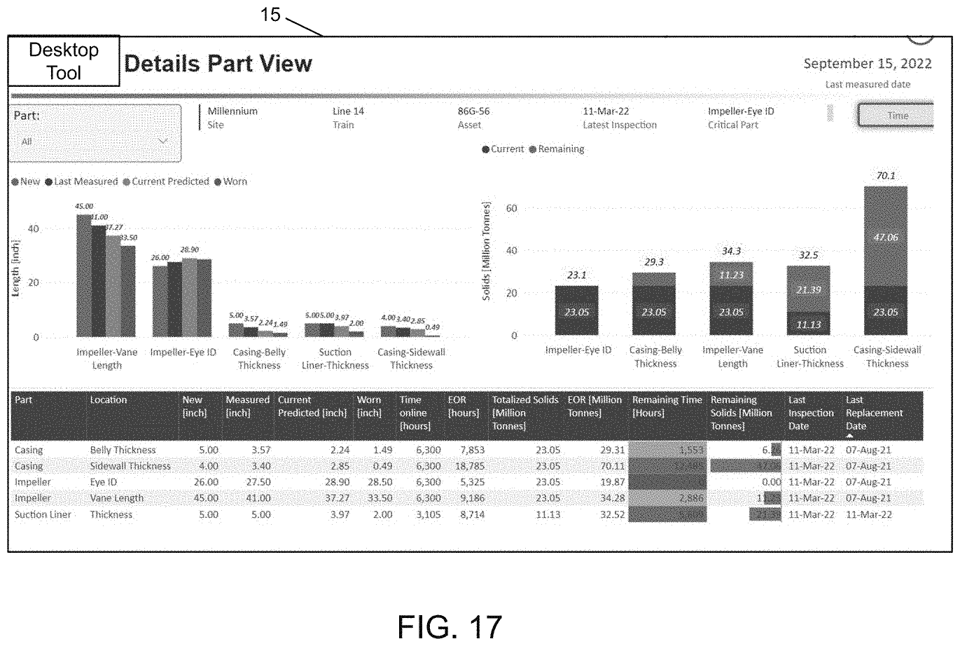

Referring now to FIG. 16, a user interface provided by the desktop tool 15 is shown. This user interface provides an area overview to provide remaining time and other variables for an area broken down by equipment 32 or line of equipment 32. FIG. 17 illustrates a similar view but for a specific part or component 33. Here, additional details for a component can be viewed and data entry made to perform a more detailed and comprehensive assessment, which may or may not occur in the field. For example, the desktop tool 15 can be used by engineers and other personnel within the enterprise system 12 to conduct in-depth analyses and model inspection, model creation, report generation, escalation/alerts, etc. Specifically, the desktop tool 15 facilitates the convenient assessment of multiple equipment 32 together (e.g., pumps in a train at site 30N in FIG. 1). Different equipment trains can also be compared to each other to ascertain if certain conditions are causing higher or lower wear relative to others. The desktop tool 15 also allow features of linked tables such that a lot of different information that facilitates in depth analysis. The field application can be limited in screen space and limits the user to view each equipment 32 or component 33 at a time, which is less convenient and more time consuming when trying to assess the overall state of an operating unit/facility.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

It will also be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory computer readable medium which can be used to store the desired information and which can be accessed by an application, module, or both. Any such computer storage media may be part of the enterprise system 12, computing device 13, mobile device 34, equipment 32, control system 36, network 22, equipment management engine 14, maintenance system 16, or any component of or related thereto, etc., or accessible or connectable thereto. Any application or module herein described may be implemented using computer readable/executable instructions that may be stored or otherwise held by such computer readable media.

The steps or operations in the flow charts and diagrams described herein are provided by way of example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as having regard to the appended claims in view of the specification as a whole.

1. A computer-implemented method for monitoring equipment, comprising:
obtaining a trained model for an item, the item comprising equipment or a component of the equipment, the model having been trained using historical operational data of the type of equipment, and historical wear data acquired by inspecting the type of equipment and/or the type of component;
using the trained model to generate an end-of-run prediction for the item using current or post service field inspection data for the item;
analyzing the end-of-run prediction to determine a maintenance recommendation; and
generating an output based on the prediction.

2. The method of claim 1, wherein the end-of-run prediction further considers current operational data associated with the item.

3. The method of claim 1, wherein the maintenance recommendation comprises a replacement recommendation.

4. The method of claim 1, wherein the maintenance recommendation comprises a reuse or continued use recommendation.

5. The method of claim 1, wherein the current field inspection data is received from a mobile field application utilized at a site comprising the item.

6. The method of claim 5, wherein the current field inspection data comprises at least one measurement indicative of wear of the item.

7. The method of claim 1, further comprising using the current field inspection data and current operational data to update the trained model.

8. The method of claim 1, wherein the trained model is one of a plurality of trained models, each trained model being associated with a different type of equipment or a different type of component.

9. The method of claim 1, wherein the equipment comprises a slurry pump and the item comprises at least one component of the slurry pump.

10. The method of claim 9, wherein the at least one component comprises one or more of a casing, a suction liner, an impeller, or a hub liner.

11. The method of claim 9, wherein the operational data comprises one or more physical properties of the equipment and/or a medium interacting with the equipment.

12. The method of claim 11, wherein the operational data comprises one or more of cumulative hours, a speed and/or a head the pump is creating, a percent Best Efficiency Point (BEP) flow; or any one or more of i) a size distribution, ii) an amount of any solids that are being pumped, iii) a density of the slurry, and iv) where the pump operates.

13. The method of claim 1, wherein the output based on the prediction comprises a notification.

14. The method of claim 13, wherein a first notification is provided to a first user device indicative of new data being provided from the site, and a second notification is provided by the first user device to a second user device and is indicative of a recommendation based on the prediction.

15. The method of claim 1, wherein the output based on the prediction comprises an alert.

16. The method of claim 15, wherein the alert is indicative of a predicted end-of-run for the item being within a threshold amount of time for that type of item.

17. The method of claim 13, wherein the output based on the prediction is provided at least in part by a mobile field application and/or is viewable in a user interface provided by a computing device.

18. The method of claim 17, wherein the user interface provides wear data and operational data for a plurality of items.

19. The method of claim 18, wherein the user interface provides a parts view comprising data for a plurality of components of the equipment.

20. A computer readable medium comprising computer executable instructions for monitoring equipment, the computer executable instructions comprising instructions for:
obtaining a trained model for an item, the item comprising equipment or a component of the equipment, the model having been trained using historical operational data of the type of equipment, and historical wear data acquired by inspecting the type of equipment and/or the type of component;
using the trained model to generate an end-of-run prediction for the item using current or post service field inspection data for the item;
analyzing the end-of-run prediction to determine a maintenance recommendation; and
generating an output based on the prediction.

21. An equipment monitoring system, comprising:
one or more processors; and
memory, the memory storing computer executable instructions that, when executed by the one or more processors, cause the system to:
obtain a trained model for an item, the item comprising equipment or a component of the equipment, the model having been trained using historical operational data of the type of equipment, and historical wear data acquired by inspecting the type of equipment and/or the type of component;
use the trained model to generate an end-of-run prediction for the item using current or post service field inspection data for the item;
analyze the end-of-run prediction to determine a maintenance recommendation; and
generate an output based on the prediction.
